(19) United States
(12) Patent Application Publication
(10) Pub. No.: US 2007/0192643 A1
(43) Pub. Date: Aug. 16, 2007

(54) Power saving system and method for devices based on universal serial bus

(75) Inventors: Shi Henry Li, Shanghai (CN); Daniel Xu, Shanghai (CN)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Semiconductor Manufacturing International (Shanghai) Corporation, Shanghai (CN)

(21) Appl. No.: 11/490,839

(22) Filed: Jul. 21, 2006

(30) Foreign Application Priority Data
Feb. 16, 2006 (CN) 200610023916.4

(51) Int. Cl. G06F 1/26

(52) U.S. Cl. 713/320

(57) ABSTRACT

A system and method for adjusting power consumption of a USB-based device. The system includes a power supply configured to generate a first supply voltage, a controller configured to receive the first supply voltage and generate a control signal, and a USB component configured to receive the control signal and in response operate in a first USB mode or a second USB mode. The controller is further configured to process information associated with the first supply voltage and a predetermined threshold voltage. If the first supply voltage is higher than the predetermined threshold voltage, the control signal represents a first logic state. If the first supply voltage is lower than the predetermined threshold voltage, the control signal represents a second logic state.

### CROSS-REFERENCES TO RELATED APPLICATIONS

This application claims priority to Chinese Patent Application No. 200610023916.4, filed Feb. 16, 2006, commonly assigned, incorporated by reference herein for all purposes.

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK

NOT APPLICABLE

### BACKGROUND OF THE INVENTION

The present invention is directed to integrated circuits. More particularly, the invention provides a power saving system and method for devices based on universal serial bus (USB). Merely by way of example, the invention has been applied to portable devices. But it would be recognized that the invention has a much broader range of applicability.

Integrated circuits or “ICs” have evolved from a handful of interconnected devices fabricated on a single chip of silicon to millions of devices. Current ICs provide performance and complexity far beyond what was originally imagined. In order to achieve improvements in complexity and circuit density (i.e., the number of devices capable of being packed onto a given chip area), the size of the smallest device feature, also known as the device “geometry”, has become smaller with each generation of ICs. Semiconductor devices are now being fabricated with features less than a quarter of a micron across.

Increasing circuit density has not only improved the complexity and performance of ICs but has also provided lower cost parts to the consumer. An IC fabrication facility can cost hundreds of millions, or even billions, of dollars. Each fabrication facility will have a certain throughput of wafers, and each wafer will have a certain number of ICs on it. Therefore, by making the individual devices of an IC smaller, more devices may be fabricated on each wafer, thus increasing the output of the fabrication facility. Making devices smaller is very challenging, as a given process, device layout, and/or system design often work down to only a certain feature size.

An example of such a limit is power consumption of a universal serial bus (USB) chip for portable devices. Excessive power consumption can shorten battery usage time before recharging is needed. Additionally, the high power consumption can generate a significant amount of heat, which can adversely affect device performance and even damage device components if proper protective measures are not adopted.

From the above, it is seen that an improved technique for managing power consumption for USB-based devices is desired.

### BRIEF SUMMARY OF THE INVENTION

The present invention is directed to integrated circuits. More particularly, the invention provides a power saving system and method for devices based on universal serial bus (USB). Merely by way of example, the invention has been applied to portable devices. But it would be recognized that the invention has a much broader range of applicability.

In a specific embodiment, the invention provides a system for adjusting power consumption of a USB-based device. The system includes a power supply configured to generate a first supply voltage, a controller configured to receive the first supply voltage and generate a control signal, and a USB component configured to receive the control signal and in response operate in a first USB mode or a second USB mode. The controller is further configured to process information associated with the first supply voltage and a predetermined threshold voltage. If the first supply voltage is higher than the predetermined threshold voltage, the control signal represents a first logic state. If the first supply voltage is lower than the predetermined threshold voltage, the control signal represents a second logic state. The USB component is further configured to operate in the first USB mode if the control signal represents the first logic state, and to operate in the second USB mode if the control signal represents the second logic state. The first USB mode is associated with a first power consumption level, and the second USB mode is associated with a second power consumption level. The first power consumption level and the second power consumption level are different.

According to another embodiment, a system for adjusting power consumption of a USB-based device includes a power supply configured to generate a first supply voltage, a controller configured to receive the first supply voltage and generate a control signal, and a USB component configured to receive the control signal and in response operate in a first USB mode or a second USB mode. The power supply is further configured to generate the first supply voltage at a first voltage level if the first supply voltage is converted from an AC voltage. The power supply is further configured to generate the first supply voltage at a second voltage level if the first supply voltage is directly supplied by a battery, or is converted from a first DC voltage supplied by the battery. The controller is further configured to process information associated with the first supply voltage and a predetermined threshold voltage. If the first supply voltage is higher than the predetermined threshold voltage, the control signal represents a first logic state. If the first supply voltage is lower than the predetermined threshold voltage, the control signal represents a second logic state. The USB component is further configured to operate in the first USB mode if the control signal represents the first logic state, and to operate in the second USB mode if the control signal represents the second logic state. The first USB mode is associated with a first power consumption level, and the second USB mode is associated with a second power consumption level. The first voltage level is higher than the second voltage level, and the first power consumption level is higher than the second power consumption level.

According to yet another embodiment, a method for adjusting power consumption of a USB-based device includes generating a first supply voltage, processing information associated with the first supply voltage, generating a control signal based on at least information associated with the first supply voltage, receiving the control signal, and in response to the control signal, switching between a first USB mode and a second USB mode. The generating a control signal includes processing information associated with the first supply voltage and a predetermined threshold voltage. If the first supply voltage is higher than the predetermined threshold voltage, the control signal represents a first logic state, and if the first supply voltage is lower than the predetermined threshold voltage, the control signal represents a second logic state. The switching between a first USB mode and a second USB mode includes switching from the first USB mode to the second USB mode if the control signal changes from representing the first logic state to representing the second logic state, and switching from the second USB mode to the first USB mode if the control signal changes from representing the second logic state to representing the first logic state. The first USB mode is associated with a first power consumption level, and the second USB mode is associated with a second power consumption level. The first power consumption level and the second power consumption level are different.

Many benefits are achieved by way of the present invention over conventional techniques. Some embodiments of the present invention provide a system and method for reducing power consumption at architectural level if the supply voltage for a USB-based device is originated from a battery. Certain embodiments of the present invention provide a system and method for adjusting USB power consumption based on voltage comparison. For example, if the supply voltage for a USB-based device is lower, the USB device operates in a USB mode that supports a lower data rate in order to save power. In another example, if the supply voltage for a USB-based device is higher, the USB device operates in another USB mode that supports a higher data rate in order to improve performance. Some embodiments of the present invention utilize a controller to provide control signals for adjusting mode of operation for a USB device. Depending upon the embodiment, one or more of these benefits may be achieved. These and other benefits will be described in more detail throughout the present specification and more particularly below.

Various additional objects, features and advantages of the present invention can be more fully appreciated with reference to the detailed description and accompanying drawings that follow.

### BRIEF DESCRIPTION OF THE DRAWINGS

FIG. 1 is a simplified system for adjusting USB power consumption according to an embodiment of the present invention;

FIG. 2 is a simplified controller used for system for adjusting USB power consumption according to an embodiment of the present invention;

FIG. 3 is a simplified voltage comparator used for system for adjusting USB power consumption according to an embodiment of the present invention;

FIG. 4 is a simplified diagram showing performance of controller used for system for adjusting USB power consumption according to an embodiment of the present invention.

### DETAILED DESCRIPTION OF THE INVENTION

The present invention is directed to integrated circuits. More particularly, the invention provides a power saving system and method for devices based on universal serial bus (USB). Merely by way of example, the invention has been applied to portable devices. But it would be recognized that the invention has a much broader range of applicability.

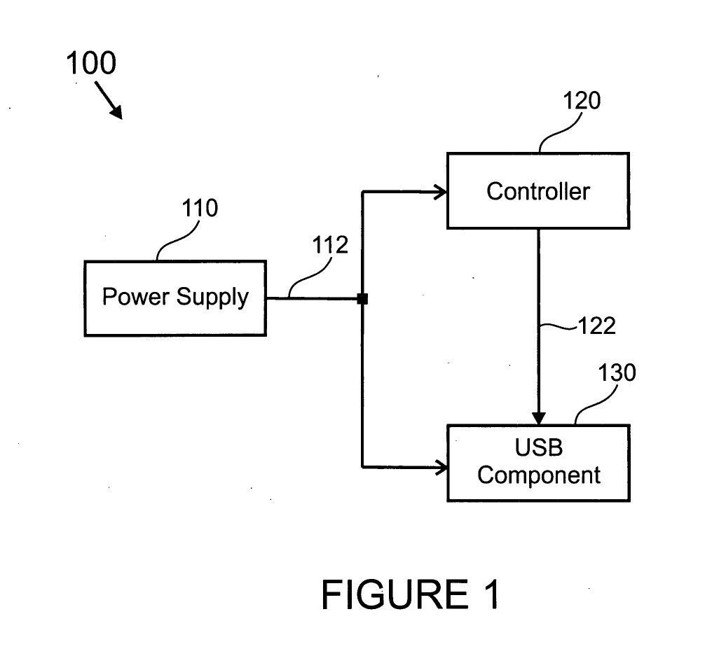

FIG. 1 is a simplified system for adjusting USB power consumption according to an embodiment of the present invention. This diagram is merely an example, which should not unduly limit the scope of the claims. One of ordinary skill in the art would recognize many variations, alternatives, and modifications. The system 100 includes the following components:
1. Power Supply 110;
2. Controller 120;
3. USB Component 130.

Although the above has been shown using a selected group of components for the system 100, there can be many alternatives, modifications, and variations. For example, some of the components may be expanded and/or combined. Other components may be inserted to those noted above. Depending upon the embodiment, the arrangement of components may be interchanged with others replaced. Further details of these components are found throughout the present specification and more particularly below.

The power supply 110 provides a supply voltage 112 to the controller 120 and the USB component 130. For example, the supply voltage 112 is a direct current (DC) voltage. In one embodiment, the power supply 110 receives an alternating current (AC) voltage from an AC power source and converts the AC voltage to the supply voltage 112. For example, the AC voltage is received through a wall socket. In another embodiment, the supply voltage 112 is originated from a battery. For example, the supply voltage 112 is directly provided by the battery. In another example, the supply voltage 112 is converted from a voltage supplied by the battery.

In one embodiment, the supply voltage is at a first voltage level if the supply voltage is originated from the AC power source. In another embodiment, the supply voltage is at a second voltage level if the supply voltage is originated from the battery. For example, the first voltage level is higher than the second voltage level.

The controller 120 receives the supply voltage 112 and in response generates a control signal 122. If the supply voltage 112 is at a first voltage level, the control signal 122 requests a first USB mode that supports a first data rate. If the supply voltage 112 is at a second voltage level, the control signal 122 requests a second USB mode that supports a second data rate. For example, the first data rate is higher than the second data rate.

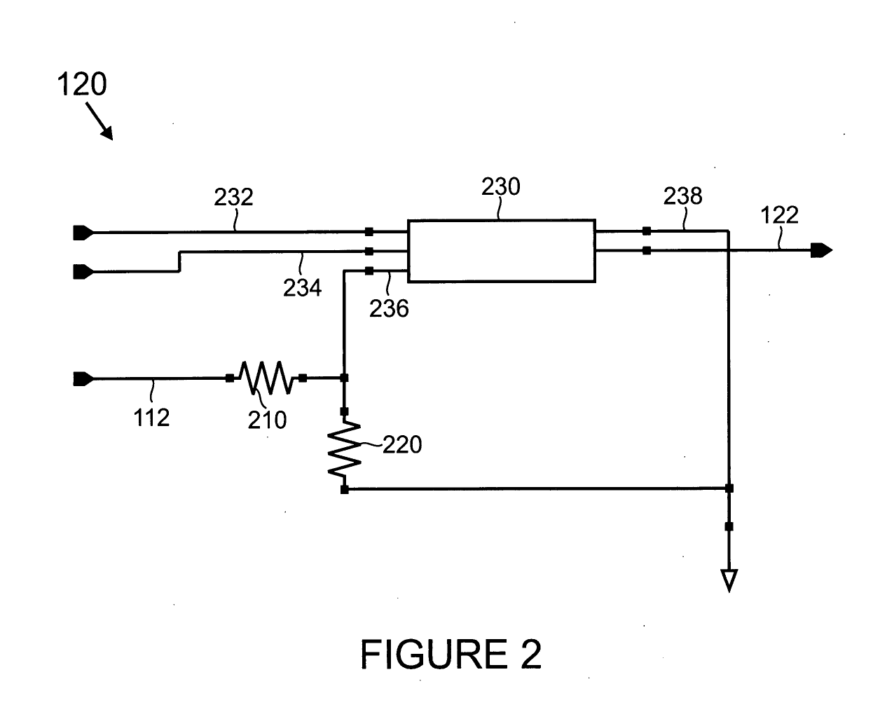

FIG. 2 is a simplified controller used for system for adjusting USB power consumption according to an embodiment of the present invention. This diagram is merely an example, which should not unduly limit the scope of the claims. One of ordinary skill in the art would recognize many variations, alternatives, and modifications. The controller 120 includes resistors 210 and 220 and voltage comparator 230.

The resistors 210 and 220 serve as a voltage divider for the supply voltage 112. The voltage divider converts the supply voltage 112 to an input voltage 236. The input voltage 236 is received by the voltage comparator 230. As shown in FIG. 2, the voltage comparator 230 also receives a supply voltage 232, a bandgap reference voltage 234, and a ground voltage 238. For example, the supply voltage 232 is the same as the supply voltage 112. In another example, the supply voltage 232 is different from the supply voltage 112. In one embodiment, the supply voltage 232 is generated using the supply voltage 112. In another embodiment, the bandgap reference voltage 234 is supplied by a bandgap reference voltage generator.

The voltage comparator 230 compares the input voltage 236 with the bandgap reference voltage 234. In response to the comparison, the control signal 122 is at a logic high level or a logic low level. For example, if the input voltage 236 is higher than the bandgap reference voltage 234, the control signal 122 is at the logic high level. In another example, if the input voltage 236 is lower than the bandgap reference voltage 234, the control signal 122 is at the logic low level. In yet another example, if the input voltage 236 is equal to the bandgap reference voltage 234, the control signal 122 is within a predetermined voltage range. As an example, the control signal 122 stays at the logic low level for a very short period of time.

According to an embodiment, the ratio of the supply voltage 112 to the input voltage 236 is represented by S. For example, a predetermined voltage is equal to the bandgap reference voltage 234 multiplied by S. If the supply voltage 112 is higher than the predetermined threshold voltage, the control signal 122 is at the logic high level. If the supply voltage 112 is lower than the predetermined threshold voltage, the control signal 122 is at the logic low level. In yet another example, if the supply voltage 112 is equal to the predetermined threshold voltage, the control signal 122 is within a predetermined voltage range. As an example, the control signal 122 stays at the logic low level for a very short period of time.

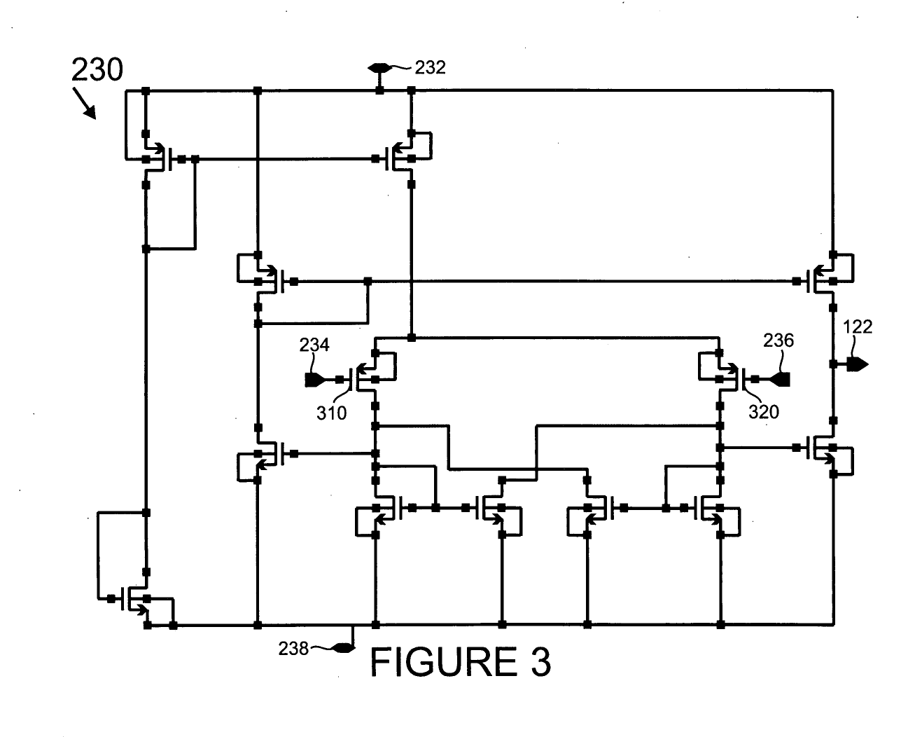

FIG. 3 is a simplified voltage comparator used for system for adjusting USB power consumption according to an embodiment of the present invention. This diagram is merely an example, which should not unduly limit the scope of the claims. One of ordinary skill in the art would recognize many variations, alternatives, and modifications. The voltage comparator 230 includes a plurality of transistors that are biased between the supply voltage 232 and the ground voltage 238. For example, the supply voltage 232 is equal to 1.8 volts. As shown in FIG. 3, the plurality of transistors includes transistors 310 and 320. The gate of the transistor 310 receives the bandgap reference voltage 234, and the gate of the transistor 320 receives the input voltage 236. For example, the bandgap reference voltage 234 is equal to 0.4 volts. If the input voltage 236 is higher than 0.4 volts, the control signal 122 is at the logic high level. If the input voltage 236 is lower than 0.4 volts, the control signal 122 is at the logic low level. In yet another example, if the input voltage 236 is equal to 0.4 volts, the control signal 122 is within a predetermined voltage range. As an example, the control signal 122 stays at the logic low level for a very short period of time.

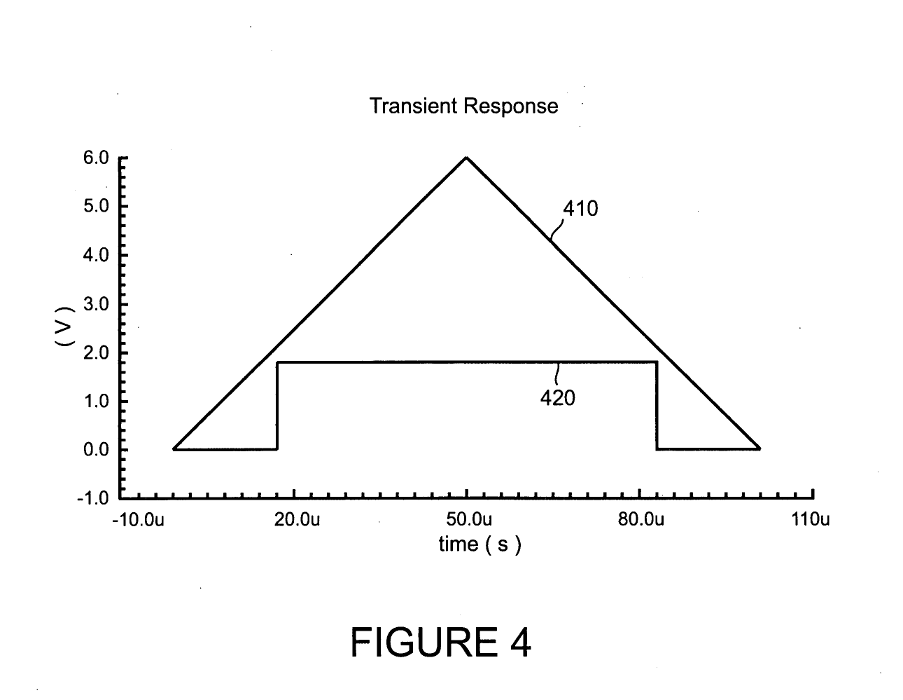

FIG. 4 is a simplified diagram showing performance of controller used for system for adjusting USB power consumption according to an embodiment of the present invention. This diagram is merely an example, which should not unduly limit the scope of the claims. One of ordinary skill in the art would recognize many variations, alternatives, and modifications.

As shown in FIG. 2, the controller 120 includes the resistors 210 and 220. For example, the resistor 210 has resistance of 4 KΩ, and the resistor 220 has resistance of 1 KΩ. Hence the ratio of the supply voltage 112 to the input voltage 236 is equal to 5, and the predetermined threshold voltage becomes 2.0 volts if the bandgap reference voltage 234 equals 0.4 volts.

In FIG. 4, curve 410 describes the supply voltage 112 as a function of time, and curve 420 describes the control signal 122 as a function of time. If the supply voltage 112 is higher than the predetermined threshold voltage of 2.0 volts, the control signal 122 is at the logic high level. If the supply voltage 112 is lower than the predetermined threshold voltage of 2.0 volts, the control signal 122 is at the logic low level. If the supply voltage 112 is equal to the predetermined threshold voltage of 2.0 volts, the control signal 122 is within a predetermined voltage range. For example, the logic high level is represented by the power supply voltage 232 of 1.8 volts, and the logic low level is represented by the ground voltage.

Returning to FIG. 1, the USB component 130 receives the supply voltage 112 and the control signal 122. In response to the control signal 122, the USB component 130 operates in either the first USB mode or the second USB mode. For example, if the control signal 122 is at the logic high level, the USB component 130 operates in the first USB mode. If the control signal 122 is at the logic low level, the USB component 130 operates in the second USB mode. In one embodiment, the first USB mode is USB 2.0, which can support a data rate of 480 megabits per second (Mbps). In another embodiment, the second USB mode is USB 1.1, which can support a data rate of 12 Mbps. The operation of the USB component 130 in either the first USB mode or the second USB mode uses the supply voltage 112.

According to another embodiment, a system for adjusting power consumption of a USB-based device includes a power supply configured to generate a first supply voltage, a controller configured to receive the first supply voltage and generate a control signal, and a USB component configured to receive the control signal and in response operate in a first USB mode or a second USB mode. The controller is further configured to process information associated with the first supply voltage and a predetermined threshold voltage. If the first supply voltage is higher than the predetermined threshold voltage, the control signal represents a first logic state. If the first supply voltage is lower than the predetermined threshold voltage, the control signal represents a second logic state. The USB component is further configured to operate in the first USB mode if the control signal represents the first logic state, and to operate in the second USB mode if the control signal represents the second logic state. The first USB mode is associated with a first power consumption level, and the second USB mode is associated with a second power consumption level. The first power consumption level and the second power consumption level are different. For example, the system is implemented according to the system 100.

According to yet another embodiment, a system for adjusting power consumption of a USB-based device includes a power supply configured to generate a first supply voltage, a controller configured to receive the first supply voltage and generate a control signal, and a USB component configured to receive the control signal and in response operate in a first USB mode or a second USB mode. The power supply is further configured to generate the first supply voltage at a first voltage level if the first supply voltage is converted from an AC voltage. The power supply is further configured to generate the first supply voltage at a second voltage level if the first supply voltage is directly supplied by a battery, or is converted from a first DC voltage supplied by the battery. The controller is further configured to process information associated with the first supply voltage and a predetermined threshold voltage. If the first supply voltage is higher than the predetermined threshold voltage, the control signal represents a first logic state. If the first supply voltage is lower than the predetermined threshold voltage, the control signal represents a second logic state. The USB component is further configured to operate in the first USB mode if the control signal represents the first logic state, and to operate in the second USB mode if the control signal represents the second logic state. The first USB mode is associated with a first power consumption level, and the second USB mode is associated with a second power consumption level. The first voltage level is higher than the second voltage level, and the first power consumption level is higher than the second power consumption level. For example, the system is implemented according to the system 100.

According to yet another embodiment, a method for adjusting power consumption of a USB-based device includes generating a first supply voltage, processing information associated with the first supply voltage, generating a control signal based on at least information associated with the first supply voltage, receiving the control signal, and in response to the control signal, switching between a first USB mode and a second USB mode. The generating a control signal includes processing information associated with the first supply voltage and a predetermined threshold voltage. If the first supply voltage is higher than the predetermined threshold voltage, the control signal represents a first logic state, and if the first supply voltage is lower than the predetermined threshold voltage, the control signal represents a second logic state. The switching between a first USB mode and a second USB mode includes switching from the first USB mode to the second USB mode if the control signal changes from representing the first logic state to representing the second logic state, and switching from the second USB mode to the first USB mode if the control signal changes from representing the second logic state to representing the first logic state. The first USB mode is associated with a first power consumption level, and the second USB mode is associated with a second power consumption level. The first power consumption level and the second power consumption level are different.

For example, the method is performed by the system 100. In another example, the first power consumption level is higher than the second power consumption level. In yet another example, the first USB mode is associated with USB 2.0, and the second USB mode is associated with USB 1.1. In yet another example, the first supply voltage is a DC voltage. In yet another example, the method further includes generating the first supply voltage at a first voltage level if the first supply voltage is converted from an AC voltage, and generating the first supply voltage at a second voltage level if the first supply voltage is directly supplied by a battery, or is converted from a DC voltage supplied by the battery. The first voltage level is higher than the second voltage level. In yet another example, the first logic state is associated with a logic high level, and the second logic state is associated with a logic low level.

The present invention has various advantages. Some embodiments of the present invention provide a system and method for reducing power consumption at architectural level if the supply voltage for a USB-based device is originated from a battery. Certain embodiments of the present invention provide a system and method for adjusting USB power consumption based on voltage comparison. For example, if the supply voltage for a USB-based device is lower, the USB device operates in a USB mode that supports a lower data rate in order to save power. In another example, if the supply voltage for a USB-based device is higher, the USB device operates in another USB mode that supports a higher data rate in order to improve performance. Some embodiments of the present invention utilize a controller to provide control signals for adjusting mode of operation for a USB device.

It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A system for adjusting power consumption of a USB-based device, the system comprising:
a power supply configured to generate a first supply voltage;
a controller configured to receive the first supply voltage and generate a control signal;
a USB component configured to receive the control signal and in response operate in a first USB mode or a second USB mode;
wherein:
the controller is further configured to process information associated with the first supply voltage and a predetermined threshold voltage;
if the first supply voltage is higher than the predetermined threshold voltage, the control signal represents a first logic state;
if the first supply voltage is lower than the predetermined threshold voltage, the control signal represents a second logic state;
the USB component is further configured to operate in the first USB mode if the control signal represents the first logic state, and to operate in the second USB mode if the control signal represents the second logic state;
the first USB mode is associated with a first power consumption level;
the second USB mode is associated with a second power consumption level;
the first power consumption level and the second power consumption level are different.

2. The system of claim 1 wherein the first power consumption level is higher than the second power consumption level.

3. The system of claim 1 wherein:
the first USB mode is associated with USB 2.0;
the second USB mode is associated with USB 1.1.

4. The system of claim 1 wherein the first supply voltage is a DC voltage.

5. The system of claim 1 wherein:
the power supply is configured to generate the first supply voltage at a first voltage level if the first supply voltage is converted from an AC voltage;
the power supply is configured to generate the first supply voltage at a second voltage level if the first supply voltage is directly supplied by a battery, or is converted from a DC voltage supplied by the battery.

6. The system of claim 5 wherein the first voltage level is higher than the second voltage level.

7. The system of claim 1 wherein the USB component is further configured to receive the first supply voltage.

8. The system of claim 1 wherein:
the controller includes a voltage divider and a voltage comparator;
the voltage divider is configured to receive the first supply voltage and generate an input voltage, the input voltage being proportional to the first supply voltage;
the voltage comparator is configured to receive the input voltage and a reference voltage, process information associated with the input voltage and the reference voltage, and generate the control signal.

9. The system of claim 8 wherein the reference voltage is a bandgap reference voltage.

10. The system of claim 8 wherein:
if the input voltage is higher than the reference voltage, the control signal represents the first logic state;
if the input voltage is lower than the reference voltage, the control signal represents the second logic state.

11. The system of claim 8 wherein:
the voltage comparator is further configured to receive a second supply voltage and a ground voltage;
the first supply voltage and the second supply voltage can be the same or different.

12. The system of claim 1 wherein:
the first logic state is associated with a logic high level;
the second logic state is associated with a logic low level.

13. A system for adjusting power consumption of a USB-based device, the system comprising:
a power supply configured to generate a first supply voltage;
a controller configured to receive the first supply voltage and generate a control signal;
a USB component configured to receive the control signal and in response operate in a first USB mode or a second USB mode;
wherein:
the power supply is further configured to generate the first supply voltage at a first voltage level if the first supply voltage is converted from an AC voltage;
the power supply is further configured to generate the first supply voltage at a second voltage level if the first supply voltage is directly supplied by a battery, or is converted from a first DC voltage supplied by the battery;
the controller is further configured to process information associated with the first supply voltage and a predetermined threshold voltage;
if the first supply voltage is higher than the predetermined threshold voltage, the control signal represents a first logic state;
if the first supply voltage is lower than the predetermined threshold voltage, the control signal represents a second logic state;
the USB component is further configured to operate in the first USB mode if the control signal represents the first logic state, and to operate in the second USB mode if the control signal represents the second logic state;
the first USB mode is associated with a first power consumption level;
the second USB mode is associated with a second power consumption level;
the first voltage level is higher than the second voltage level;
the first power consumption level is higher than the second power consumption level.

14. The system of claim 13 wherein:
the first USB mode is associated with USB 2.0;
the second USB mode is associated with USB 1.1.

15. A method for adjusting power consumption of a USB-based device, the method comprising:
generating a first supply voltage;
processing information associated with the first supply voltage;
generating a control signal based on at least information associated with the first supply voltage;
receiving the control signal;
in response to the control signal, switching between a first USB mode and a second USB mode;
wherein:
the generating a control signal includes processing information associated with the first supply voltage and a predetermined threshold voltage;
if the first supply voltage is higher than the predetermined threshold voltage, the control signal represents a first logic state;
if the first supply voltage is lower than the predetermined threshold voltage, the control signal represents a second logic state;
wherein the switching between a first USB mode and a second USB mode includes:
switching from the first USB mode to the second USB mode if the control signal changes from representing the first logic state to representing the second logic state;
switching from the second USB mode to the first USB mode if the control signal changes from representing the second logic state to representing the first logic state;
wherein:
the first USB mode is associated with a first power consumption level;
the second USB mode is associated with a second power consumption level;
the first power consumption level and the second power consumption level are different.

16. The method of claim 15 wherein the first power consumption level is higher than the second power consumption level.

17. The method of claim 15 wherein:
the first USB mode is associated with USB 2.0;
the second USB mode is associated with USB 1.1.

18. The method of claim 15 wherein the first supply voltage is a DC voltage.

19. The method of claim 15, and further comprising:
generating the first supply voltage at a first voltage level if the first supply voltage is converted from an AC voltage;
generating the first supply voltage at a second voltage level if the first supply voltage is directly supplied by a battery, or is converted from a DC voltage supplied by the battery.

20. The method of claim 19 wherein the first voltage level is higher than the second voltage level.

21. The method of claim 15 wherein:
the first logic state is associated with a logic high level;
the second logic state is associated with a logic low level.
